(19) United States
(12) Patent Application Publication
(10) Pub. No.: US 2026/0084116 A1
(43) Pub. Date: Mar. 26, 2026

(54) SYSTEMS AND METHODS INCLUDING FUSED PARTICLE MEMBRANES FOR FILTRATION

(71) Applicant: Rensselaer Polytechnic Institute, Troy, NY (US)

(72) Inventors: GEORGES BELFORT, North Falmouth, MA (US); JOEL PLAWSKY, Albany, NY (US); SURYA KARLA, Troy, NY (US); MIRCO SORCI, Troy, NY (US)

(73) Assignee: Rensselaer Polytechnic Institute, Troy, NY (US)

(21) Appl. No.: 19/400,293

(22) Filed: Nov. 25, 2025

Related U.S. Application Data
(63) Continuation-in-part of application No. PCT/US2024/031560, filed on May 30, 2024.
(60) Provisional application No. 63/469,692, filed on May 30, 2023.
(60) Provisional application No. 63/547,204, filed on Nov. 3, 2023.
(60) Provisional application No. 63/652,787, filed on May 29, 2024.
(60) Provisional application No. 63/924,769, filed on Nov. 25, 2025.

(51) Int. Cl. B01D 69/02; B01D 67/00; B01D 71/06

(52) U.S. Cl. CPC B01D 69/02; B01D 67/00041; B01D 67/0006; B01D 71/06; B01D 2325/06

(57) ABSTRACT

Rigid or flexible polymer membranes including one contiguous porous film are provided that include a plurality of fused microstructures, e.g., microspheres, teardrops, ellipsoids, other geometric designs, or combinations thereof. The microstructures are fused via a sintering, chemical, and/or physical process, crosslinking, or combinations thereof. The membranes have a plurality of repeating microstructures in a random or ordered, e.g., face-centered cubic, arrangement and a network of throats extending through the membrane and around the fused microstructures. The microstructures and throats precisely control the microstructure of the membrane, providing consistent and uniform flow across the membrane in all three directions. Channeling concerns of polymeric membranes cast using random statistical processes, such as phase inversion and interfacial polymerization, are thus reduced. The membranes provide consistent filtration performance, e.g., of proteins and nucleic acid mixtures, while reducing the compressibility, pore wall flexibility, and ageing limitations of traditional polymeric membranes. Surface modification of the microstructures can further enhance membrane selectivity for a given separation.

### CROSS-REFERENCE TO RELATED APPLICATIONS

This application is a continuation-in-part of International Patent Application No. PCT/US2024/031560, filed May 30, 2024, which claims the benefit of U.S. Provisional Patent Application Nos. 63/469,692, filed May 30, 2023, 63/547,204, filed Nov. 3, 2023, and 63/652,787, filed May 29, 2024, which are incorporated by reference as if disclosed herein in their entireties. This application also claims the benefit of U.S. Provisional Patent Application No. 63/924,769, filed Nov. 25, 2025, which is incorporated by reference as if disclosure herein in its entirety.

### BACKGROUND

Polymeric membranes are the most widely used types of membranes in industry, particularly in the biotechnology and desalination industries. Despite being economical and offering the capability to roughly control the average pore sizes to a obtain more tight or open pore structure, traditional polymeric membrane casting methods can struggle to achieve and maintain the desired selectivities, particularly in cases with small and/or similarly sized components for separation. Commercial polymeric membranes are typically formed using phase inversion or interfacial polymerization processes. These processes are random stochastic processes, and membranes cast using these processes can exhibit severe channeling that negatively influences solute selectivity. This is due the lack of precise control over the porous microstructure formed.

Referring now to FIG. 1, fluid dynamics studies on membrane filtration in commercial polymeric membranes showed significant channeling. An analysis of a pore-throat network in the commercial membranes demonstrated the extent to which the equivalent pore diameter can vary across the membrane structure. Further, empirical processes configured to reduce the effects of channeling and improve selectivity in polymeric membranes are expensive and time consuming. Other limitations of traditional polymeric membranes are compressibility, pore wall flexibility, and ageing.

What is desired, therefore, are processes for producing membranes that allow for increased control over the membrane microstructure to limit variation in pore/throat size and provide for more consistent selectivity while facilitating separation of solutes differing in size, e.g., by less than an order of magnitude. Additionally, it is desired for the membranes produced by these methods to avoid the disadvantageous compressibility, pore flexibility, ageing/durability, fouling, and concentration polarization issues associated with commercial polymeric membranes.

### SUMMARY

Aspects of the present disclosure are directed to processes to rationally design and synthesize rigid polymeric or rigid non-polymeric membranes including different geometric particles. Some embodiments of the present disclosure are directed to membrane materials synthesized by combining different rigid geometric particles, such as spheres, teardrops, ellipsoids, and other geometric designs of the same or different diameters, that are non-attached or covalently attached and linked, e.g., crosslinked, to each other. Some embodiments of the present disclosure are directed to rigid membranes where the pore structure can be controlled while reducing compressibility, flexibility, and aging. The chemistry of these membranes can be selected to minimize fouling due to undesired solutes, maximize adhesion with solute whose capture is desired, and the microstructure can be tuned to control the tortuosity to obtain the best separation of specific mixture, etc., or combinations thereof. In some embodiments, these membranes do not use phase inversion nor interfacial polymerization, both random statistical processes. The membrane can also allow even flow across the surface (x-y direction) and in through the membrane (in the z-direction) while reducing channeling.

Aspects of the present disclosure are directed to a rigid membrane including a plurality of fused microstructures and a network of throats extending through the membrane and around the fused microstructures. In some embodiments, the microstructures have an average diameter between about 1 nm and about 20 μm. In some embodiments, the microstructures include microspheres, teardrops, ellipsoids, or any geometric shapes or combinations thereof. In some embodiments, the microstructures include one or more treatments to a surface thereon. In some embodiments, the microstructures include poly(ether sulfone), poly(ether sulfone) derivatives, regenerated cellulose, polyamide, poly(vinylidene fluoride), polycarbonate, polyacrylonitrile, polymethylmethacrylate, polyvinyl alcohol, poly(glycidyl methacrylate), poly(lactic-co-glycolic acid), polyvinyl chloride, poly(¿-caprolactone), polypropylene, polystyrene, polyethylene, polyacrylate, polylactide, or derivatives thereof, silica, titania, gold, other suitable polymer materials, or combinations thereof. In some embodiments, the microstructures are crosslinked via a plurality of acrylate terminal linkers, aldehyde terminal linkers, or combinations thereof.

In some embodiments, a first set of microstructures having a first size, shape, flexibility, and chemistry and at least a second set of microstructures having a second size, shape, flexibility, and chemistry. In some embodiments, at least the first size and second size are different.

In some embodiments, the microstructures have an orderly packed arrangement including a face-centered cubic arrangement, body-centered cubic arrangement, simple-cubic arrangement, packing with long range order, combinations thereof. In some embodiments, the microstructures have a face-centered cubic arrangement and the membrane has a porosity between about 0.2 and about 0.3 and a tortuosity between about 1.7 and about 1.8. In some embodiments, the throats have a mean equivalent throat diameter between about 1 nm and about 10 μm. In some embodiments, the throats have a mean equivalent throat diameter of about 0.07 μm. In some embodiments, the microstructures are randomly packed. In some embodiments, the microstructures have a mean particle size of about 1-6 μm. Aspects of the present disclosure are directed to a rigid membrane including a plurality of fused microstructures having a mean particle size of about 1 μm and a network of throats extending through the rigid membrane and around the fused face-centered cubic microstructures. In some embodiments, the fused microstructures have an orderly face-centered cubic packed arrangement. In some embodiments, the throats have a mean equivalent throat diameter between about 1 nm and about 10 μm. In some embodiments, the throats have a mean equivalent throat diameter of about 0.07 μm.

Aspects of the present disclosure are directed to a method of separating a plurality of components in a mixture. In some embodiments, the method includes providing a plurality of microstructures; fusing the plurality of microstructures to form a fused membrane material having a network of throats extending through the membrane and around the fused microstructures; constructing a rigid membrane comprising at least a portion of the fused membrane material; applying a mixture to the membrane, wherein the mixture includes at least two components; and collecting a product from the membrane, wherein the product is enriched for at least one of the components of the mixture. In some embodiments, fusing the plurality of microstructures to form a fused membrane includes a sintering process, a chemical process, a physical process, or combinations thereof. In some embodiments, constructing a rigid membrane includes crosslinking the plurality of microstructures. In some embodiments, the method includes applying one or more surface treatments to the microstructures. In some embodiments, the microstructures have a face-centered cubic arrangement and the membrane has a porosity between about 0.2 and about 0.3 and a tortuosity between about 1.7 and about 1.8. In some embodiments, the microstructures have a mean particle size of about 1-6 μm and the throats have a mean equivalent throat diameter of about 0.07 μm.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1A is a graph showing a pore-throat network of a traditional polymeric membrane;

FIG. 1B is a schematic representation illustrating channeling in a commercial polymer membrane synthesized by phase inversion processes;

FIGS. 2A-2B are schematic representations of fused particle membranes according to some embodiments of the present disclosure;

FIG. 3A is a graph showing the coordination number of particles in a fused particle membrane according to some embodiments of the present disclosure;

FIG. 3B is a graph showing the equivalent throat diameter of a fused particle membrane according to some embodiments of the present disclosure;

FIG. 3C is a graph showing a pore-throat network for a fused particle membrane according to some embodiments of the present disclosure;

FIG. 4 is a chart of a method of separating a plurality of components in a mixture according to some embodiments of the present disclosure;

FIG. 5A is a schematic representation of a process of making a fused particle membrane according to some embodiments of the present disclosure;

FIG. 5B is a schematic representation of a chemical crosslinking process for use in making a fused particle membrane according to some embodiments of the present disclosure;

FIG. 6A is a graph showing size distribution of microstructures used to construct a fused particle membrane according to some embodiments of the present disclosure;

FIG. 6B is a graph showing zeta potential of microstructures used to construct a fused particle membrane according to some embodiments of the present disclosure;

FIGS. 7A-7B are atomic force microscopy images of a fused particle membrane according to some embodiments of the present disclosure;

FIG. 8 is a graph showing fluid flux through a track-etched support and fused particle membrane according to some embodiments of the present disclosure;

FIG. 9A is an image showing transport rate differences for the larger and smaller particles through a fused particle membrane according to some embodiments of the present disclosure; and

FIG. 9B is a schematic representation of particle transportation trajectory differences for the larger and smaller particles through a fused particle membrane according to some embodiments of the present disclosure.

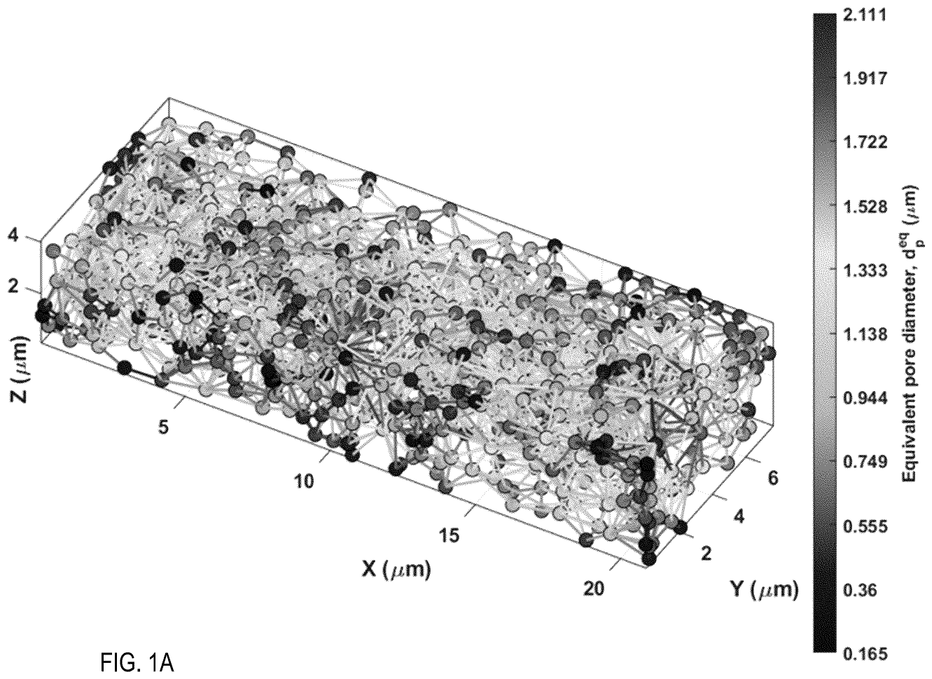

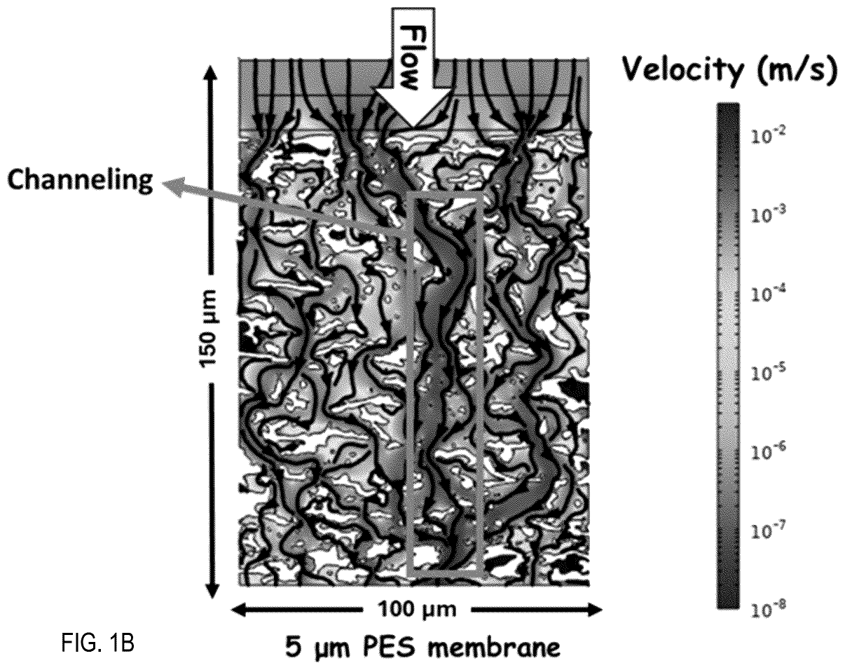

### DETAILED DESCRIPTION

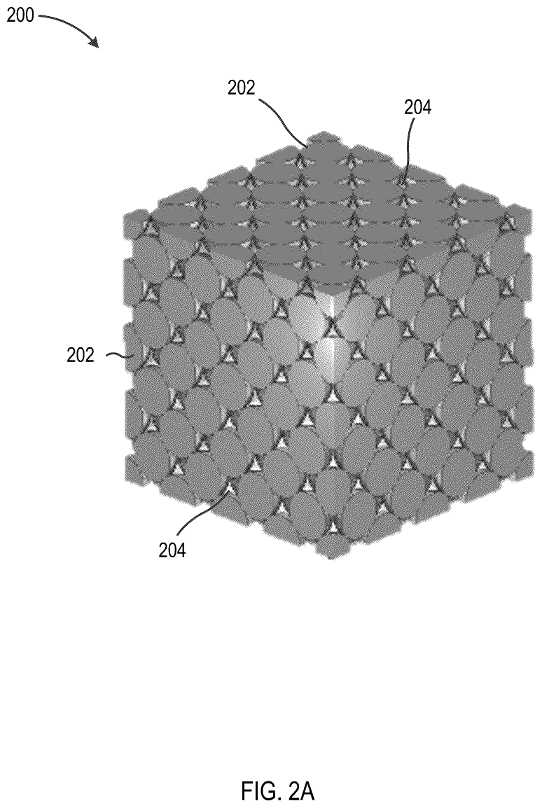

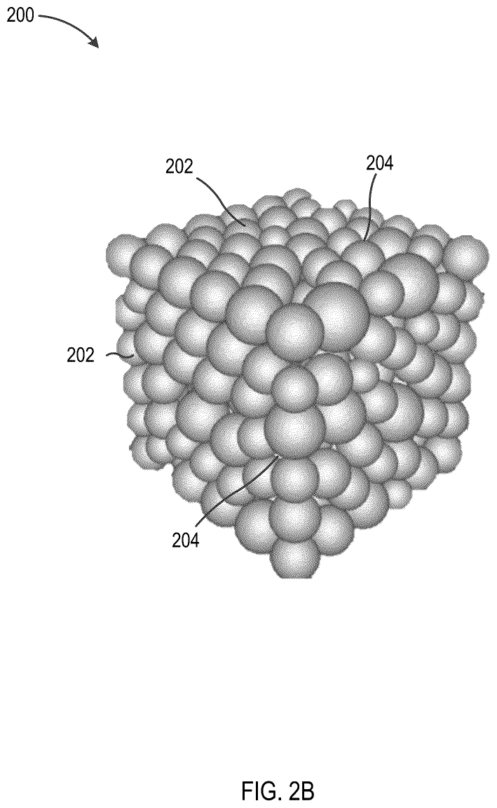

Referring now to FIG. 2, some embodiments of the present disclosure are directed to a membrane 200 configured to separate components in a sample. In some embodiments, the sample is a mixture of components. In some embodiments, the mixture includes two or more sets of particles of different sizes. In some embodiments, the sets of particles are of different sizes and within an order of magnitude of difference in size. The particles suitable for separation using membrane 200 will be understood by those of skill in the art and will be discussed in greater detail below, however, in various embodiments, the particles include proteins, nucleic acids, etc., or combinations thereof. In some embodiments, membrane 200 is a rigid membrane. In some embodiments, membrane 200 is a non-rigid membrane. In some embodiments, membrane 200 is a flexible membrane. In some embodiments, membrane 200 includes a plurality of microstructures 202. In some embodiments, plurality of microstructures 202 are fused, e.g., to adjacent microstructures in the membrane. As used herein, the term “microstructures” can refer to particles having a micro-scale diameter, e.g., above 1 μm, as well as smaller particles of sufficient size to form the fused membranes consistent with embodiments of the present disclosure, e.g., nanoscale particles, particles above about 0.7 μm, etc., as will be discussed in greater detail below.

In some embodiments, microstructures 202 include polymeric material, non-polymeric materials, or combinations thereof. In some embodiments, microstructures 202 include a poly(aryl sulfone), a poly(aryl sulfone) derivative, polystyrene, polystyrene derivative, polymethylmethacrylate, poly(glycidyl methacrylate), poly(lactic-co-glycolic acid), polyvinyl chloride, poly(¿-caprolactone), polypropylene, polyethylene, polystyrene, polyacrylate, polylactide, regenerated cellulose, or derivatives thereof, silica, titania, gold, or any suitable polymer materials or combinations thereof. In some embodiments, microstructures 202 include poly(ether sulfone), poly(ether sulfone) derivatives, or combinations thereof. In some embodiments, the polymer “derivatives” of the present disclosure include functionalized versions of the polymer, one or more copolymers thereof, copolymers with other polymeric subunits, or combinations thereof. In some embodiments, microstructures 202 include microspheres, teardrops, ellipsoids, other geometric designs, or combinations thereof.

In some embodiments, microstructures 202 have an average diameter between about 1 nm and about 20 μm. In some embodiments, microstructures 202 have an average diameter between about 0.6 μm and about 20 μm. In some embodiments, microstructures 202 have an average diameter between about 0.7 μm and about 1 μm. In some embodiments, microstructures 202 have an average diameter between about 1 μm and about 6 μm. In some embodiments, microstructures 202 have an average diameter between about 5 μm and about 6 μm. In some embodiments, microstructures 202 have an average diameter of about 1 μm. In some embodiments, microstructures 202 have an average diameter of about 0.8 μm. In some embodiments, membrane 200 includes a first set of microstructures have a first size, shape, flexibility, and/or chemistry, and at least a second set of microstructures having a second size, shape, flexibility, and/or chemistry. In some embodiments, properties of the first set of microstructures are different from properties of the second set of microstructures, e.g., small particles inside the gaps between larger packed particles. In various embodiments, both small and large microparticles 202 could be different in shape, size and chemistry to form membrane 200 with a range of particles of different types, e.g., flexibility, size, shape, and chemistry.

In some embodiments, microstructures 202 are crosslinked via a plurality of linkers. In some embodiments, microstructures 202 are crosslinked via a plurality of acrylate terminal linkers, aldehyde terminal linkers, or combinations thereof. In some embodiments, microstructures 202 include one or more treatments to a surface thereon. Various embodiments of crosslinking chemistry include hydrophilic (3-(trimethoxysilyl) propyl methacrylate plus N-vinyl pyrrolidone; methacrylic acid plus gelatin (hydrogel); aminoethyl methacrylate plus organic acid; glycidyl methacrylate plus primary amine; hydrophobic poly(methyl methacrylate) plus divinyl benzene; glutaraldehyde plus primary amine; or combinations thereof.

In some embodiments, membrane 200 includes a network of throats 204 extending through the membrane and around fused microstructures 202. In some embodiments, throats 204 have a mean equivalent throat diameter between about 1 nm and about 10 μm. In some embodiments, throats 204 have a mean equivalent throat diameter between about 0.05 μm and about 0.25 μm. In some embodiments, throats 204 have a mean equivalent throat diameter between about 0.05 μm and about 0.20 μm. In some embodiments, throats 204 have a mean equivalent throat diameter between about 0.05 μm and about 0.15 μm. In some embodiments, throats 204 have a mean equivalent throat diameter between about 0.05 μm and about 0.10 μm. In some embodiments, throats 204 have a mean equivalent throat diameter of about 0.07 μm.

In some embodiments, microstructures 202 have an orderly packed arrangement. In some embodiments, microstructures 202 have a face-centered cubic arrangement, body-centered cubic arrangement, simple-cubic arrangement, amorphous packing with long range order, or combinations thereof. In some embodiments, membrane 200 has a porosity between about 0.2 and about 0.5. In some embodiments, membrane 200 has a porosity between about 0.2 and about 0.4. In some embodiments, membrane 200 has a porosity between about 0.2 and about 0.3. In some embodiments, membrane 200 has a porosity of about 0.24. In some embodiments, membrane 200 has a tortuosity between about 1.4 and about 1.8. In some embodiments, membrane 200 has a tortuosity between about 1.4 and about 1.5. In some embodiments, membrane 200 has a tortuosity between about 1.5 and about 1.8. In some embodiments, membrane 200 has a tortuosity between about 1.6 and about 1.8. In some embodiments, membrane 200 has a tortuosity between about 1.7 and about 1.8. In some embodiments, membrane 200 has a tortuosity of about 1.74. In some embodiments, membrane 200 has a porosity between about 0.2 and about 0.3 and a tortuosity between about 1.7 and about 1.8. In some embodiments, microstructures 202 have a face-centered cubic arrangement, and membrane 200 has a porosity between about 0.2 and about 0.3 and a tortuosity between about 1.7 and about 1.8. In some embodiments, microstructures 202 are randomly packed. In some embodiments, membrane 200 is one contiguous porous film.

Mixtures including a plurality of components, e.g., particles, can be administered to the membrane for separation and collection of one or more target components and/or component-containing products. As the mixture is transported through the membrane, e.g., via the network of throats, the rates of transport for larger and smaller particles in the mixture differ at least due to higher Brownian diffusion and lower drag on the smaller particles. Phase inversion and interfacial polymerization processes for constructing membranes are both random statistical processes, and as a result are prone to contain statistically variant flow paths through the membranes that are difficult to control, and thus exhibit increased statistical variation in separation within the same membrane or across a batch of membranes even for the same starting mixture. Fused microstructures 202 consistent with embodiments of the present disclosure allow for more even flow through membrane 200 while limiting the issues with channeling. The surfaces of microstructures 202 can also be treated to increase selectivity for a specific separation.

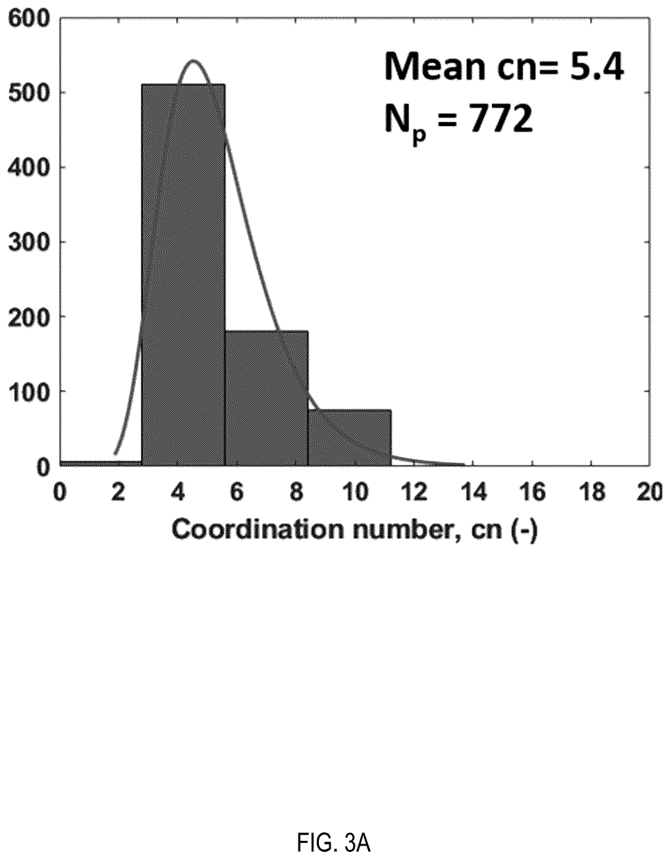

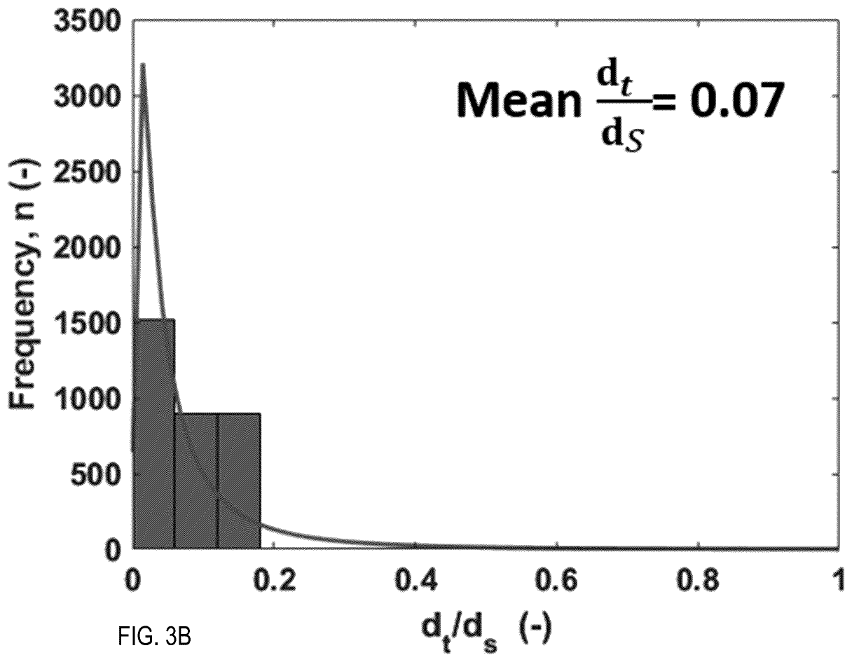

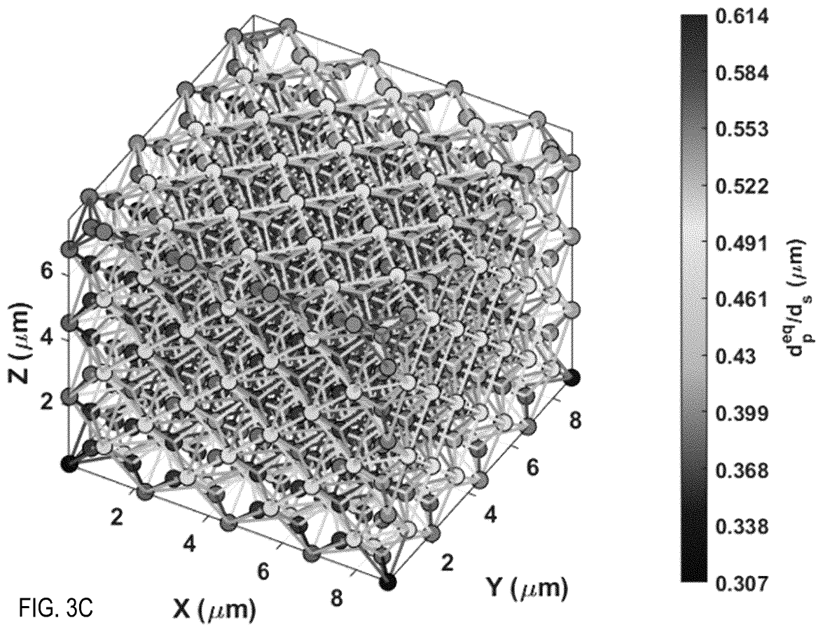

Referring now to FIGS. 3A-3C, a rigid membrane consistent with various embodiments of the present disclosure was prepared. The rigid membrane included a plurality of fused orderly face-centered cubic packed microspheres and a network of throats extending through the rigid membrane and around the fused face-centered cubic arrangement of microstructures. The microspheres had a mean particle size of about 1 μm, which provided a mean coordination number of about 5.4 in the fused microstructure network (see FIG. 3A). The curve shows the lognormal fit, where cn is coordination number of the pores and Nₚ is the number of pores. The throats had a mean equivalent throat diameter of about 0.07 μm (see FIG. 3B). In this graph, dt was equivalent throat diameter and dₛ was sphere diameter. The throats provided for a dense pore network through which a mixture would traverse through the membrane (see FIG. 3C). In this graph, dₚ^{eq} was equivalent pore diameter and dₛ was sphere diameter. The membrane was found to have a porosity of about 0.24 and a tortuosity of about 1.74.

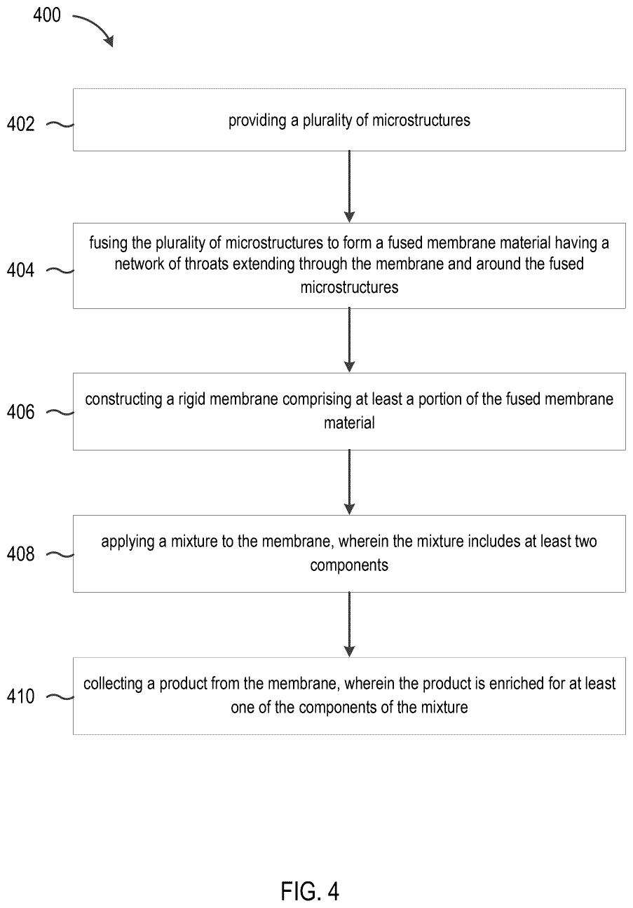

Referring now to FIG. 4, some embodiments of the present disclosure are directed to a method 400 of separating a plurality of components in a mixture, e.g., a plurality of sets of particles. At 402, a plurality of microstructures are provided. As discussed above, in some embodiments, the microstructures include polymeric material, non-polymeric materials, or combinations thereof. In some embodiments, the microstructures include a poly(aryl sulfone), a poly(aryl sulfone) derivative, polystyrene, polystyrene derivative, polymethylmethacrylate, poly(glycidyl methacrylate), poly(lactic-co-glycolic acid), polyvinyl chloride, poly(¿-caprolactone), polypropylene, polyethylene, polystyrene, polyacrylate, polylactide, regenerated cellulose, or derivatives thereof, silica, titania, gold, or any suitable polymer materials, or combinations thereof. In some embodiments, the microstructures include poly(ether sulfone), poly(ether sulfone) derivatives, or combinations thereof. In some embodiments, the microstructures include one or more treatments to a surface thereon. In some embodiments, the microstructures include microspheres, teardrops, ellipsoids, other geometric designs, or combinations thereof. In some embodiments, the microstructures have an average diameter between about 1 nm and about 20 μm. In some embodiments, the microstructures have an average diameter between about 0.6 μm and about 20 μm. In some embodiments, the microstructures have an average diameter between about 0.7 μm and about 1 μm. In some embodiments, the microstructures have an average diameter between about 1 μm and about 6 μm. In some embodiments, the microstructures have an average diameter between about 5 μm and about 6 μm. In some embodiments, the microstructures have an average diameter of about 1 μm. In some embodiments, the microstructures have an average diameter of about 0.8 μm.

In some embodiments, at 404, the plurality of microstructures are fused together to form a fused membrane material. In some embodiments, fusing 404 the plurality of microstructures to form a fused membrane includes a sintering process, a chemical process, a physical process, or combinations thereof. In various embodiments, when the particles are synthesized with light sensitive poly(aryl sulfones), exposure of UV_{300 nm} enables the particles to be fused 404 and form the fused membrane material. In various embodiments, microstructures are dispersed in a solution, e.g., ethanol, and cast on a porous support one or more times to create multiple layers of stacked microstructures, as will be discussed in greater detail below.

In some embodiments, the microstructures in the fused membrane material have an orderly packed arrangement. In some embodiments, the microstructures in the fused membrane material have a face-centered cubic arrangement, body-centered cubic arrangement, simple-cubic arrangement, packing with long range order, or combinations thereof. In some embodiments, the microstructures in the fused membrane material are randomly packed.

In some embodiments, at 406, a membrane including at least a portion of the fused membrane material is constructed. As discussed above, in some embodiments, the membranes have a network of throats extending through the membrane and around the fused microstructures. In some embodiments, the throats have a mean equivalent throat diameter between about 1 nm and about 10 μm. In some embodiments, the throats have a mean equivalent throat diameter between about 0.05 μm and about 0.25 μm. In some embodiments, the throats have a mean equivalent throat diameter between about 0.05 μm and about 0.20 μm. In some embodiments, the throats have a mean equivalent throat diameter between about 0.05 μm and about 0.15 μm. In some embodiments, the throats have a mean equivalent throat diameter between about 0.05 μm and about 0.10 μm. In some embodiments, the throats have a mean equivalent throat diameter of about 0.07 μm. In some embodiments, fusing 404 and constructing 406 occur in the same process.

In some embodiments, the microstructures in the membrane have a mean particle size of about 1-6 μm and the throats have a mean equivalent throat diameter of about 0.07 μm. In some embodiments, the membrane has a porosity between about 0.2 and about 0.5. In some embodiments, the membrane has a porosity between about 0.2 and about 0.4. In some embodiments, the membrane has a porosity between about 0.2 and about 0.3. In some embodiments, the membrane has a porosity of about 0.24. In some embodiments, the membrane has a tortuosity between about 1.4 and about 1.8. In some embodiments, the membrane has a tortuosity between about 1.4 and about 1.5. In some embodiments, the membrane has a tortuosity between about 1.5 and about 1.8. In some embodiments, the membrane has a tortuosity between about 1.6 and about 1.8. In some embodiments, the membrane has a tortuosity between about 1.7 and about 1.8. In some embodiments, the membrane has a tortuosity of about 1.74. In some embodiments, the membrane has a porosity between about 0.2 and about 0.3 and a tortuosity between about 1.7 and about 1.8. In some embodiments, the microstructures have a face-centered cubic arrangement, and the membrane has a porosity between about 0.2 and about 0.3 and a tortuosity between about 1.7 and about 1.8. As used therein, tortuosity is defined as the ratio of the actual distance travelled through a porous media to the linear distance from the entrance to the exit, e.g.:

$$τ = ( \frac{D}{{D}^{eff}} ) ϵ$$

where τ is the tortuosity, D is unhindered diffusivity of the solute, D^{eff} is hindered diffusivity of the solute in the porous media, and of the solute, and E is the porosity of the porous media.

In some embodiments, the plurality of microstructures in the membrane material are crosslinked. In some embodiments, the plurality of microstructures are crosslinked during fusing 404, as a separate crosslinking process, or combinations thereof. As discussed above, in various embodiments, microstructures are dispersed in a solution, e.g., ethanol, and cast on a porous support. In some embodiments, the microstructures are then treated with a crosslinker solution to crosslink he cast microstructures. In some embodiments, casting and crosslinking are repeated at least twice in an effort to produce a membrane including a plurality of crosslinked microstructure layers. As discussed above, in some embodiments, the plurality of microstructures in the fused membrane material are crosslinked via a plurality of linkers. In some embodiments, the plurality of microstructures are crosslinked via a plurality of acrylate terminal linkers, aldehyde terminal linkers, or combinations thereof. Various embodiments of crosslinking chemistry include hydrophilic (3-(trimethoxysilyl) propyl methacrylate plus N-vinyl pyrrolidone; methacrylic acid plus gelatin (hydrogel); aminoethyl methacrylate plus organic acid; glycidyl methacrylate plus primary amine; hydrophobic poly(methyl methacrylate) plus divinyl benzene; glutaraldehyde plus primary amine; or combinations thereof.

At 408, a mixture is applied to the membrane. In some embodiments, the mixture includes two or more components, the separation of which is desired. In some embodiments, the components in the mixture include proteins and nucleic acids. In some embodiments, at least one of the components is a vaccine. In some embodiments, at 410, a product enriched for at least one of the components of the mixture is collected from the membrane.

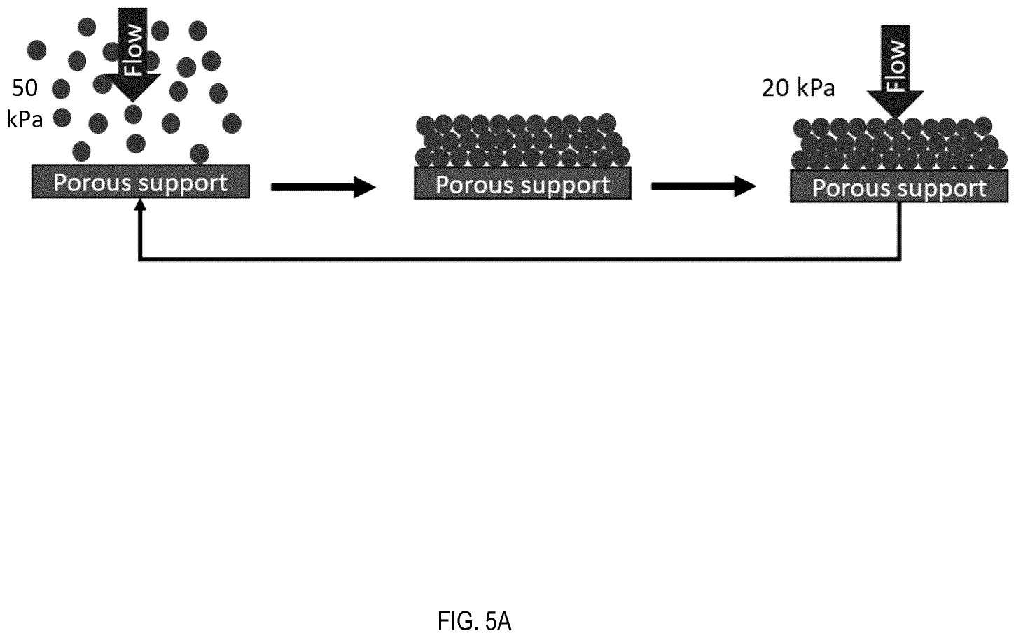

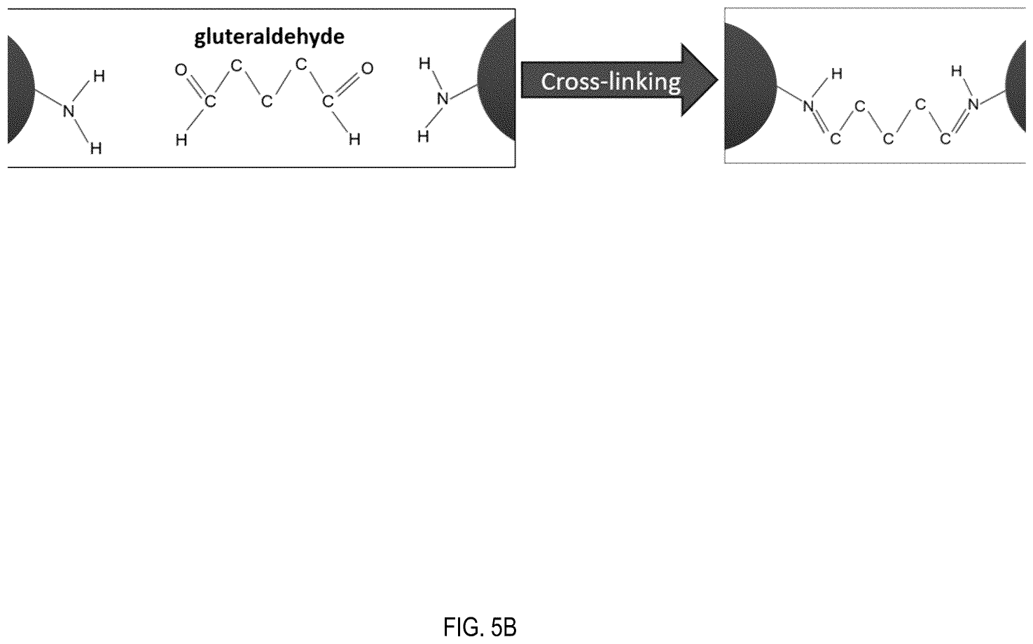

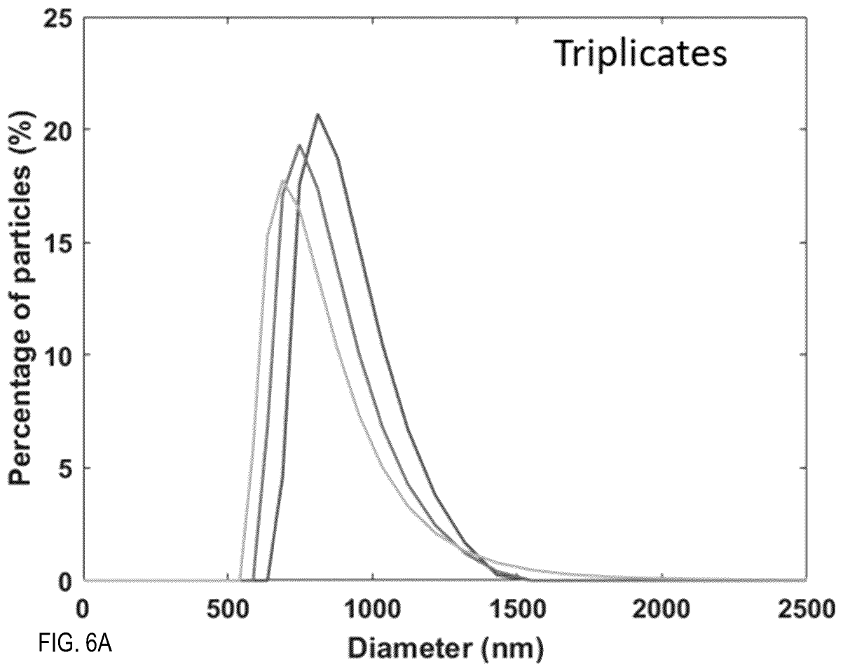

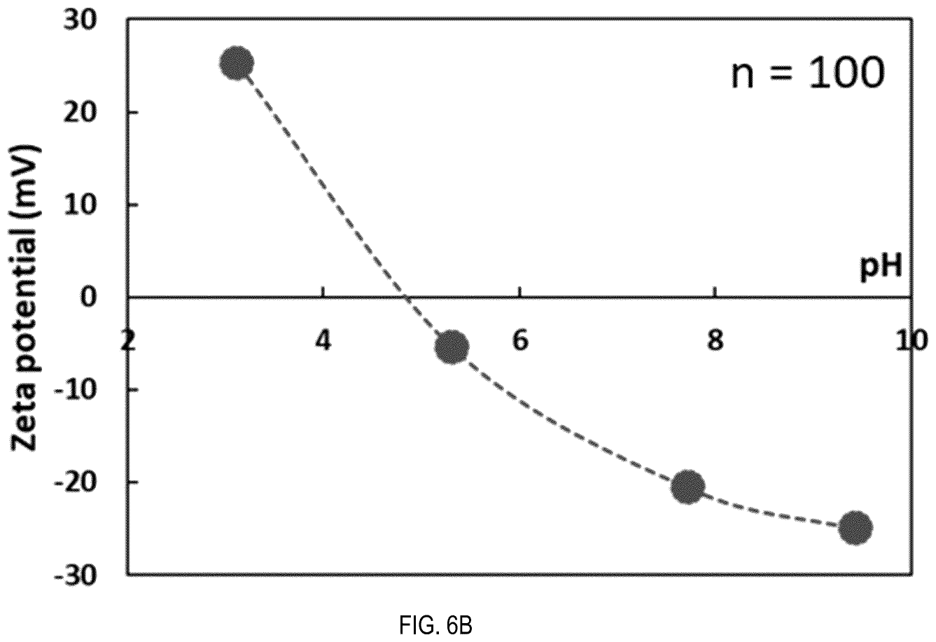

Referring now to FIGS. 5A-5B, a membrane consistent with various embodiments of the present disclosure was prepared. A 200 nm track-etched polycarbonate porous support membrane was provided and contacted with a mixture of microstructures. The microstructures in the mixture were amine-modified polystyrene particles. The particles were previously tested and determined to have an average diameter of 783 nm±126 nm (a polydispersity of 1.36), and an isoelectric point of about 4.8 (see FIGS. 6A-6B). A 0.04 mg/mL dispersion of these particles was prepared in ethanol, and 4 mL of the mixture was contacted with the porous support. Upon settling of the microstructures, 2 mL of an 8% aqueous glutaraldehyde solution was contacted with the microstructures to crosslink the microstructures consistent with the example chemistry shown in FIG. 5B. Two cycles of the support/mixture contacting and subsequent crosslinking was performed in an effort to provide a membrane having approximately 8 layers of microstructures.

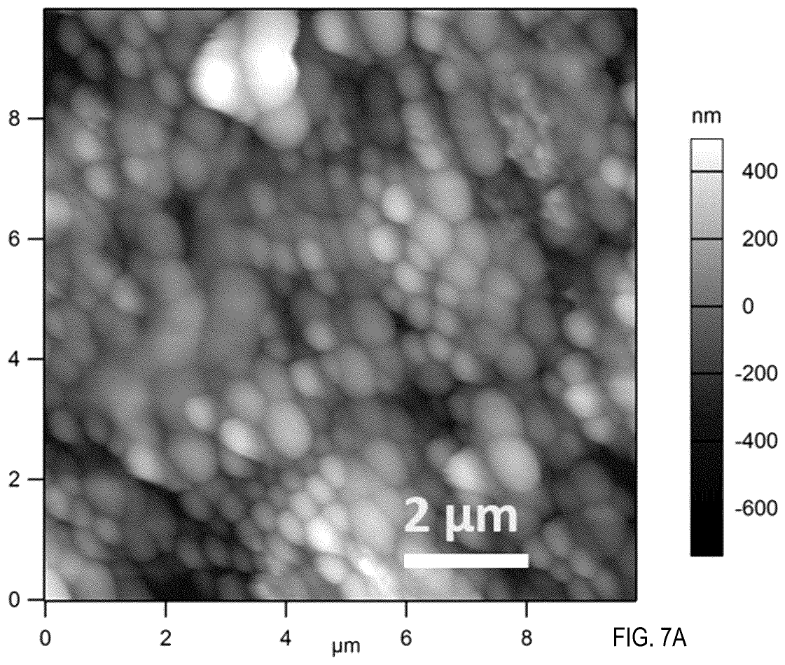

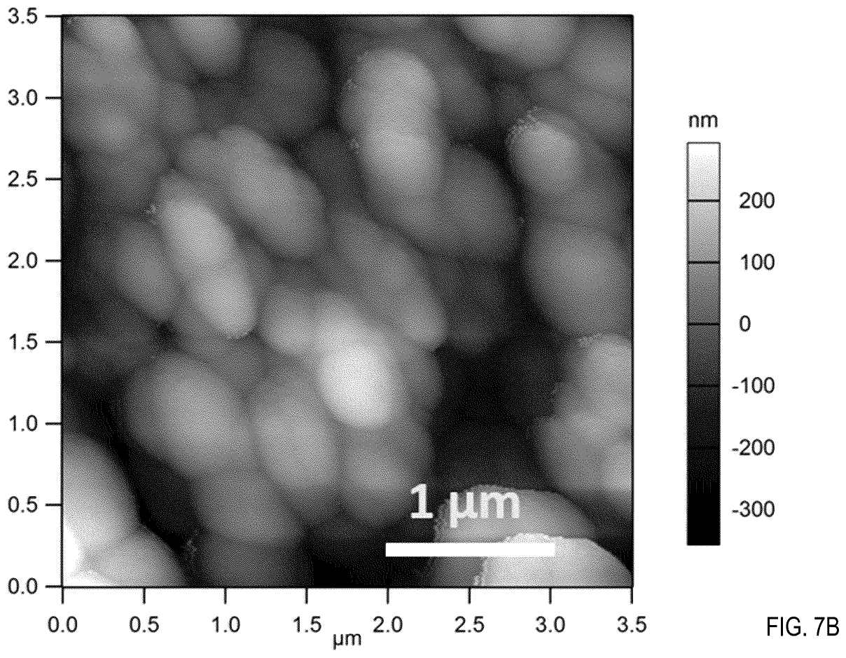

Referring now to FIGS. 7A-7B, atomic force microscopy was used to image the fused microstructure membrane prepared in FIGS. 5A-5B. These images demonstrate tight, random packing of the microstructures in the membrane consistent with embodiments of the present disclosure.

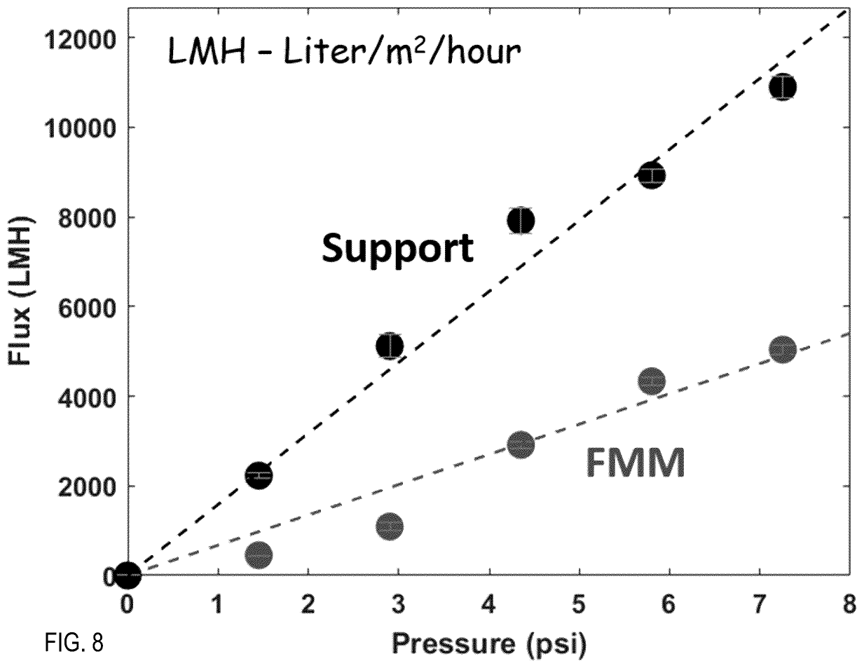

Referring now to FIG. 8, the water permeability and resistance of the fused microstructure membrane from FIGS. 5A-5B was tested relative to the polycarbonate support membrane. The fused microstructure membrane demonstrated lower permeability and higher resistance compared to the polycarbonate support membrane. Further, each layer of the fused microstructure membrane demonstrated approximately 9.4633×10⁻⁵ psi of fluid flow resistance.

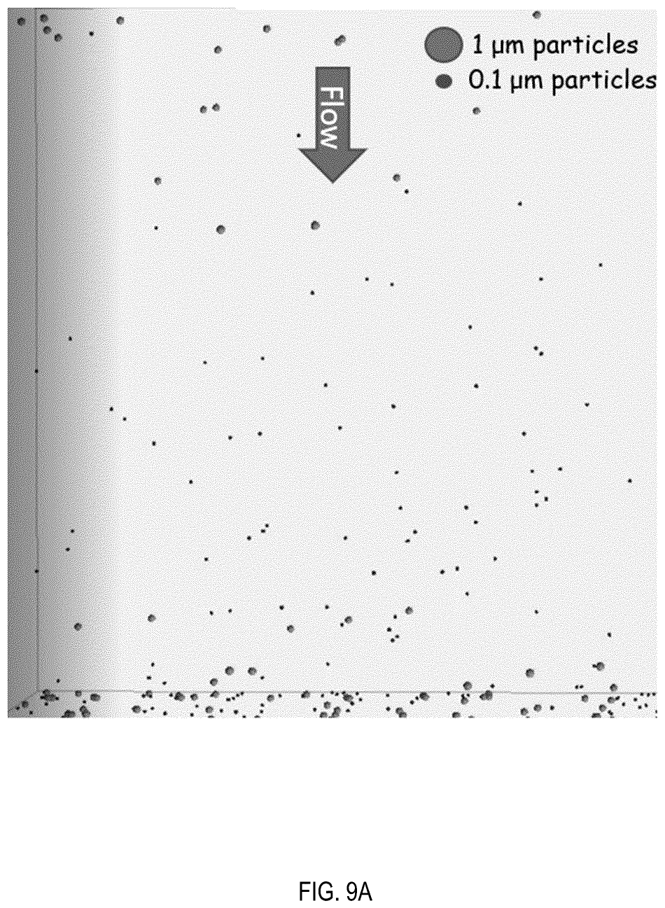

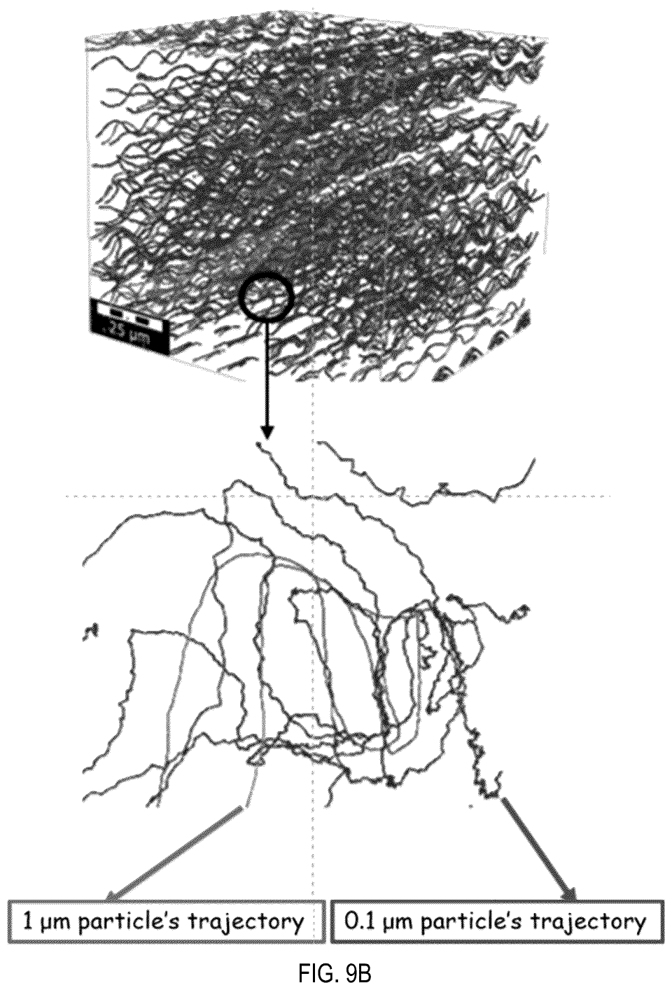

Referring now to FIGS. 9A-9B, computational fluid dynamics simulations were performed on an 80×80×80 μm fused microsphere membrane to visualize the performance of membranes consistent with various embodiments of the present disclosure in separating 1 and 0.1 μm mean diameter particles. Microspheres of 10 μm mean diameter were packed densely and regularly. The largest diameter spherical particle that can just pass through a pore was estimated to be 1.76 μm. The difference in transport rate for the larger and smaller particles was identified. Without wishing to be bound by theory, these rate differences can be attributed to higher Brownian diffusion and lower drag on the smaller particles (see FIG. 9A). Higher Brownian diffusion in the case of smaller particles can be observed by comparing the particle trajectories (see FIG. 9B).

Systems and methods of the present disclosure advantageously can provide consistent filtration performance with binary systems, e.g., proteins and nucleic acid mixtures, as well as with complex mixtures. A rational approach to minimize channeling is to synthesize a membrane with a precisely controlled microstructure. The membranes include a plurality of repeating microstructures, such as microspheres, that provide consistent and durable flow channels across the membrane. Channeling concerns of membranes cast using random statistical processes, such as phase inversion and interfacial polymerization, are thus reduced. Surface modifications applied to the polymeric or non-polymeric fused microstructures can be applied to increase membrane selectivity for a given separation. In some embodiments using rigid materials, the compressibility, pore wall flexibility, and ageing limitation of traditional polymeric membranes can also be reduced.

In the biotech industry, membrane-based processes such as ultrafiltration, microfiltration and nanofiltration are implemented in downstream processing of various substances, such as proteins and nucleic acids related to the production of vaccines. Often the separations involving similar biomolecules can be challenging and use highly selective membranes. Embodiments of the present disclosure exhibit high permeance (with high selectivity and permeation flux) and can be beneficial for use in such cases.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A porous membrane, comprising:
a plurality of fused microstructures, the microstructures having an average diameter between about 1 nm and about 20 μm; and
a network of throats extending through the membrane and around the fused microstructures,
wherein the microstructures include microspheres, teardrops, ellipsoids, or combinations thereof.

2. The membrane according to claim 1, wherein the microstructures include one or more treatments to a surface thereon.

3. The membrane according to claim 1, wherein the microstructures include poly(ether sulfone), poly(ether sulfone) derivatives, polymethylmethacrylate, poly(glycidyl methacrylate), poly(lactic-co-glycolic acid), polyvinyl chloride, poly(ε-caprolactone), polypropylene, polyethylene, polystyrene, polyacrylate, polylactide, cellulose, derivatives thereof, silica, titania, gold, or combinations thereof.

4. The membrane according to claim 1, wherein the microstructures are crosslinked via a plurality of acrylate terminal linkers, aldehyde terminal linkers, or combinations thereof.

5. The membrane according to claim 1, wherein the microstructures have an orderly packed arrangement including a face-centered cubic arrangement, body-centered cubic arrangement, simple-cubic arrangement, packing with long range order, or combinations thereof.

6. The membrane according to claim 5, where the microstructures have a face-centered cubic arrangement and the membrane has a porosity between about 0.2 and about 0.3 and a tortuosity between about 1.7 and about 1.8.

7. The membrane according to claim 6, wherein the throats have a mean equivalent throat diameter of about 1 nm-10 μm.

8. The membrane according to claim 1, wherein the microstructures are randomly packed.

9. The membrane according to claim 1, wherein the microstructures include:
a first set of microstructures having a first size, shape, flexibility, and chemistry; and
at least a second set of microstructures having a second size, shape, flexibility, and chemistry,
wherein at least the first size and second size are different.

10. A method of separating a plurality of components in a mixture, comprising:
providing a plurality of microstructures, wherein the microstructures include microspheres, teardrops, ellipsoids, or combinations thereof;
fusing the plurality of microstructures to form a fused membrane material having a network of throats extending through the membrane and around the fused microstructures;
constructing a rigid membrane comprising at least a portion of the fused membrane material;
applying a mixture to the membrane, wherein the mixture includes at least two components; and
collecting a product from the membrane, wherein the product is enriched for at least one of the components of the mixture,
wherein fusing the plurality of microstructures to form a fused membrane comprises a sintering process, a chemical process, a physical process, or combinations thereof.

11. The method according to claim 10, wherein constructing a rigid membrane further comprises:
crosslinking the plurality of microstructures,
wherein the microstructures are crosslinked via a plurality of acrylate terminal linkers, aldehyde terminal linkers, or combinations thereof.

12. The method according to claim 10, further comprising applying one or more surface treatments to the microstructures.

13. The method according to claim 10, wherein the microstructures include poly(ether sulfone), poly(ether sulfone) derivatives, polymethylmethacrylate, poly(glycidyl methacrylate), poly(lactic-co-glycolic acid), polyvinyl chloride, poly(¿-caprolactone), polypropylene, polyethylene, polystyrene, polyacrylate, polylactide, cellulose, derivatives thereof, silica, titania, gold, or combinations thereof.

14. The method according to claim 10, wherein the membrane has an orderly packed arrangement of microstructures having a face-centered cubic arrangement, body-centered cubic arrangement, simple-cubic arrangement, packing with long range order, or combinations thereof.

15. The method according to claim 14, where the microstructures have a face-centered cubic arrangement and the membrane has a porosity between about 0.2 and about 0.3 and a tortuosity between about 1.7 and about 1.8.

16. The membrane according to claim 11, wherein the microstructures have a mean particle size of about 1 nm-20 μm and the throats have a mean equivalent throat diameter of about 1 nm-10 μm.

17. The method according to claim 11, wherein the microstructures are randomly packed.

18. A rigid membrane, comprising:
a plurality of fused microstructures having a mean particle size of about 1 μm, wherein the fused microstructures have an orderly face-centered cubic packed arrangement; and
a network of throats extending through the rigid membrane and around the fused face-centered cubic microstructures, wherein the throats have a mean equivalent throat diameter of about 0.07 μm,
wherein the microstructures include microspheres, teardrops, ellipsoids, or combinations thereof, and
the microstructures are composed of poly(ether sulfone), poly(ether sulfone) derivatives, polymethylmethacrylate, poly(glycidyl methacrylate), poly(lactic-co-glycolic acid), polyvinyl chloride, poly(ε-caprolactone), polypropylene, polyethylene, polystyrene, polyacrylate, polylactide, cellulose, derivatives thereof, silica, titania, gold, or combinations thereof.

19. The membrane according to claim 18, wherein the microstructures include one or more treatments to a surface thereon.

20. The method according to claim 18, wherein the microstructures are crosslinked via a plurality of acrylate terminal linkers, aldehyde terminal linkers, or combinations thereof.
